(19) United States
(12) Patent Application Publication
(10) Pub. No.: US 2025/0310525 A1
(43) Pub. Date: Oct. 2, 2025

(54) METHOD AND APPARATUS FOR VIDEO CODING USING GEOMETRIC MOTION PREDICTION

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/863,252

(22) PCT Filed: Apr. 21, 2023
(86) PCT No.: PCT/KR2023/005495

§ 371 Date: Nov. 5, 2024

(30) Foreign Application Priority Data
May 16, 2022 (KR) 10-2022-0059398
Apr. 19, 2023 (KR) 10-2023-0051381

(51) Int. Cl. H04N 19/119; H04N 19/137; H04N 19/176

(52) U.S. Cl. CPC H04N 19/119; H04N 19/137; H04N 19/176

(57) ABSTRACT

A method and an apparatus are disclosed for video coding using geometric motion prediction. In the disclosed embodiments, a video decoding device decodes motion information for a first block partition of the current block and generates a first prediction block of the current block by using the motion information of the first block partition. The video decoding device decodes a merge candidate index for a second block partition of the current block and generates a second prediction block of the current block by using the merge candidate index. The video decoding device derives a geometric block partition shape and blends the first prediction block and the second prediction to generate a final prediction block of the current block.

### TECHNICAL FIELD

The present disclosure relates to a video coding method and an apparatus using geometric motion prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In the video coding method and device, inter prediction technology generates a prediction block by using pixels in temporally adjacent pictures to predict a current block. In order to improve the performance of inter prediction, techniques have been attempted to perform inter prediction in block units, which are the basic units of encoding and decoding, or to perform inter prediction on one block in units of one or more subblocks. However, the prediction techniques in units of blocks described above are limited to prediction using square or rectangular block partitioning, so there is difficulty in performing prediction on objects having an arbitrary shape in an image.

In order to overcome the above-described limitations, methods using arbitrary block partitioning has been attempted in addition to square or rectangular block partitioning. As a representative arbitrary block partitioning, there is a method of partitioning a square block using a straight line with an arbitrary angle. This technique was proposed and discussed during the HEVC standardization process but was not adopted as a standard technique. Afterwards, during the VVC standardization process, among the inter prediction technologies, a technology of partitioning one block using two diagonal segments and blending the partitioned blocks to generate one final inter predictor has been proposed. This technology was named triangle partition mode (TPM) and adopted in the VVC standard. In addition, during the VVC standardization process, the form of partitioning one block has been expanded to be more diverse. This technology was named a geometric partition mode (GPM) and was finally included in the VVC standard. The above-described GPM is used only in a merge mode among the inter prediction modes. Therefore, in order to improve the video coding efficiency and improve video quality, it is necessary to consider improving the GPM.

### DISCLOSURE

### Technical Problem

The present disclosure seeks to provide a video coding method and an apparatus using geometric motion prediction in the inter prediction of a current block. Here, the geometric motion prediction bisects the current block into an arbitrary shape, performs different motion prediction on each partitioned block to generate a predictor, and blends the predictors based on different weights of predefined pixel units to generate a final inter predictor.

### Technical Solution

At least one aspect of the present disclosure provides a method of decoding a current block, performed by a video decoding device. The method includes decoding motion information for a first block partition of the current block from a bitstream. The method also includes generating a first prediction block of the current block by using the motion information of the first block partition. The method also includes decoding a merge candidate index for a second block partition of the current block from the bitstream. The method also includes acquiring motion information of the second block partition from a geometric partition mode (GPM) merge list based on the merge candidate index and then generating a second prediction block of the current block by using the motion information of the second block partition. The method also includes deriving a geometric block partition shape that partitions the current block into the first block partition and the second block partition by using the first prediction block. The method also includes blending the first prediction block and the second prediction block by using the geometric block partition shape to generate a final prediction block of the current block.

Another aspect of the present disclosure provides a method of predicting a current block, performed by a video encoding device. The method includes determining motion information for a first block partition of the current block. The method also includes generating a first prediction block of the current block by using the motion information of the first block partition. The method also includes determining a merge candidate index for a second block partition of the current block. The method also includes acquiring motion information of the second block partition from a geometric partition mode (GPM) merge list based on the merge candidate index and then generating a second prediction block of the current block by using the motion information of the second block partition. The method also includes deriving a geometric block partition shape that divides the current block into the first block partition and the second block partition by using the first prediction block. The method also includes blending the first prediction block and the second prediction block by using the geometric block partition shape to generate a final prediction block of the current block.

Yet another aspect of the present disclosure provides a computer-readable recording medium that stores a bitstream generated by a video encoding method. The video encoding method includes determining motion information for a first block partition of a current block. The video encoding method also includes generating a first prediction block of the current block by using the motion information of the first block partition. The video encoding method also includes determining a merge candidate index for a second block partition of the current block. The video encoding method also includes acquiring motion information of the second block partition from a geometric partition mode (GPM) merge list based on the merge candidate index and then generating a second prediction block of the current block by using the motion information of the second block partition. The video encoding method also includes deriving a geometric block partition shape that divides the current block into the first block partition and the second block partition by using the first prediction block. The video encoding method also includes blending the first prediction block and the second prediction block by using the geometric block partition shape to generate a final prediction block of the current block.

### Advantageous Effects

As described above, the present disclosure provides a video coding method and an apparatus that use geometric motion prediction in the inter prediction of the current block. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating block partitioning for geometric motion prediction according to an embodiment of the present disclosure.

FIG. 7A and FIG. 7B are diagrams illustrating straight lines bisecting a block according to an embodiment of the present disclosure.

FIG. 8 is a diagram conceptually illustrating inter prediction using geometric partitioning.

FIG. 9 is a diagram illustrating a geometric partition mode (GPM) merge list used for geometric motion prediction.

FIG. 10 is a diagram illustrating a GPM advanced motion vector prediction (AMVP) list and a GPM merge list used for geometric motion prediction according to an embodiment of the present disclosure.

FIG. 11 is a diagram illustrating geometric motion prediction using a hybrid AMVP mode and a merge mode according to an embodiment of the present disclosure.

FIG. 12 is a flowchart illustrating a method for a video decoding device to decode motion information according to an embodiment of the present disclosure.

FIG. 13 is a flowchart illustrating a method for a video encoding device to predict a current block according to an embodiment of the present disclosure.

FIG. 14 is a flowchart illustrating a method for a video decoding device to predict a current block according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

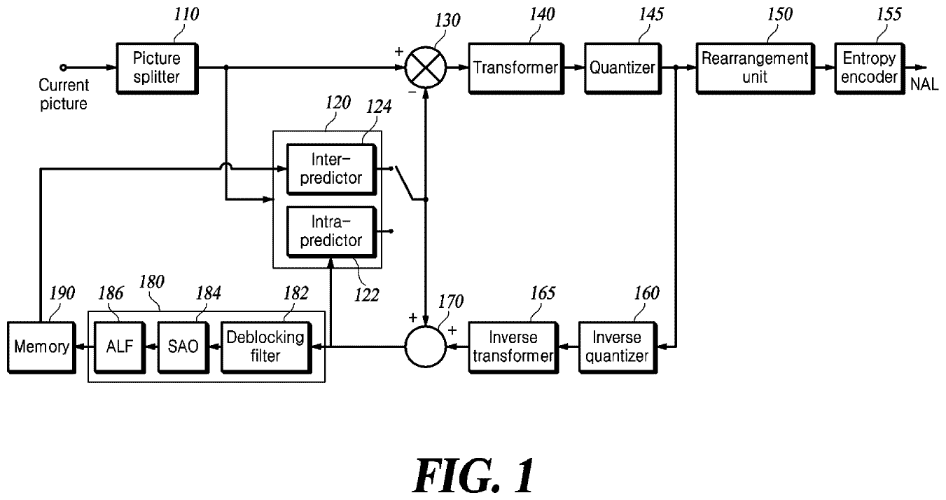

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

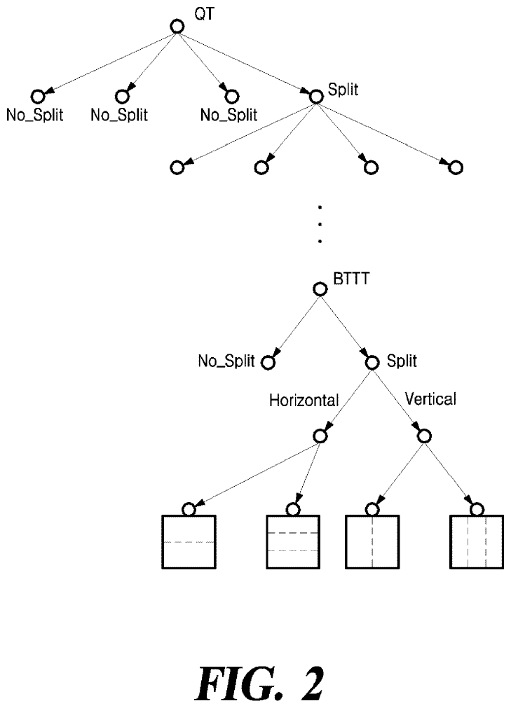

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

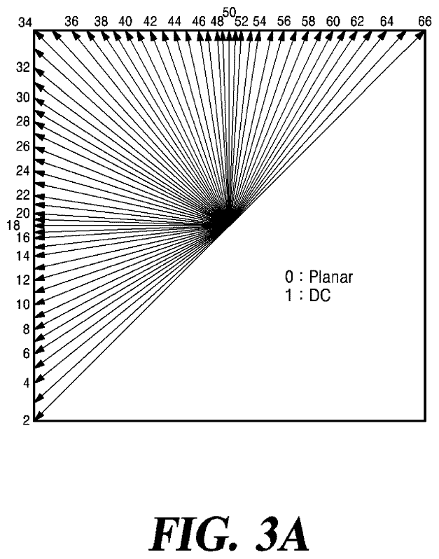

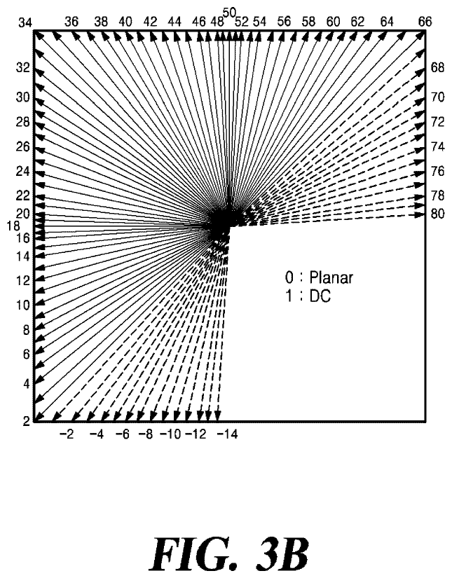

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

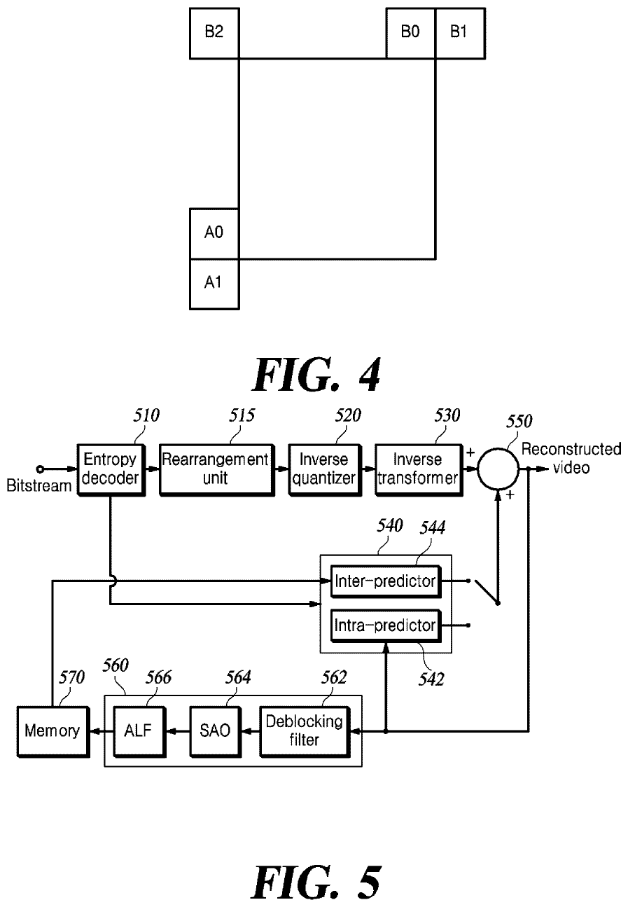

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus using geometric motion prediction in inter prediction of a current block. Here, the geometric motion prediction bisects the current block into an arbitrary shape, performs different motion prediction on each partitioned block to generate a predictor, and blends the predictors based on different weights of predefined pixel units to generate a final inter predictor.

The following embodiments may be performed by the inter predictor 124 in the video encoding device. The following embodiments may also be performed by the inter predictor 544 in the video decoding device.

The video encoding device in the prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the prediction of the current block.

In the following description, the term “target block” may be used interchangeably with the current block or coding unit (CU), or may refer to some area of a coding unit.

Further, the value of one flag being true indicates when the flag is set to 1.Additionally, the value of one flag being false indicates when the flag is set to 0.

### I. Merge/Skip Mode of Inter Prediction

The following embodiments are described based on the inter predictor 124 in the video encoding device but may also be performed by the inter predictor 544 in the video decoding device as described above.

Hereinafter, a method of configuring a merge candidate list of motion information in a merge/skip mode of inter prediction is described. In order to support the merge/skip mode, the inter predictor 124 in the video encoding device may configure a merge candidate list by selecting a preset number (e.g., 6) of merge candidates.

The inter predictor 124 searches for spatial merge candidates. The inter predictor 124 searches for spatial merge candidates from neighboring blocks as illustrated in FIG. 4. Up to 4 spatial merge candidates may be selected.

The inter predictor 124 searches for temporal merge candidates. The inter predictor 124 may add a block (co-located block) that is located in the same position as the current block in a reference picture (which may be the same as or different from a reference picture used to predict the current block) other than a current picture in which the target block is located as a temporal merge candidate. One temporal merge candidate may be selected.

The inter predictor 124 searches for history-based motion vector predictor (HMVP) candidates. The inter predictor 124 may store motion vectors of the previous h (here, h is a natural number) CUs in a table and use motion vectors as merge candidates. The table size is 6, and the motion vectors of the previous CUs are stored according to the first-in first-out (FIFO) method. This indicates that up to 6 HMVP candidates are stored in the table. The inter predictor 124 may set the most recent motion vectors among the HMVP candidates stored in the table as merge candidates.

The inter predictor 124 searches for pairwise average MVP (PAMVP) candidates. The inter predictor 124 may set the average of the motion vectors of first and second candidates in the merge candidate list as the merge candidate.

If the merge candidate list cannot be filled even after performing all of the above-described search processes (i.e., if the preset number is not filled), the inter predictor 124 adds a zero motion vector as a merge candidate.

In terms of optimizing coding efficiency, the inter predictor 124 may determine a merge index indicating one candidate in the merge candidate list. The inter predictor 124 may derive a motion vector predictor (MVP) from the merge candidate list by using the merge index, and then may determine the MVP as a motion vector of the current block. In addition, the video encoding device may signal the merge index to the video decoding device.

In the case of skip mode, the video encoding device uses the same motion vector transmission method as the merge mode but does not transmit a residual block corresponding to a difference between the current block and a prediction block.

The method of configuring the above-described merge candidate list may be performed in the same manner by the inter predictor 544 in the video decoding device. The video decoding device may decode the merge index. The inter predictor 544 may derive the MVP from the merge candidate list by using the merge index, and then may determine the MVP as the motion vector of the current block.

### II. AMVP Mode of Inter Prediction

The following embodiments are described based on the inter predictor 124 in the video encoding device but may also be performed by the inter predictor 544 in the video decoding device as described above.

Hereinafter, a method of configuring a candidate list of motion information in the AMVP mode of inter prediction is described. In order to support the AMVP mode, the inter predictor 124 in the video encoding device may select a preset number of candidates (e.g., 2) to configure the candidate list.

The inter predictor 124 searches for spatial candidates. The inter predictor 124 searches for spatial candidates from neighboring blocks as illustrated in FIG. 4. Up to two spatial candidates may be selected.

The inter predictor 124 searches for temporal candidates. The inter predictor 124 may add a block at the same position as the current block in a reference picture (which may be the same as or different from a reference picture used to predict the current block) other than the current picture in which the target block is located as a temporal candidate. One temporal candidate may be selected.

If the candidate list cannot be filled even after performing all of the above-describe search processes (i.e., if the preset number cannot be filled), the inter predictor 124 adds a zero motion vector as a candidate.

In terms of optimizing coding efficiency, the inter predictor 124 may determine a candidate index indicating one candidate in the candidate list. The inter predictor 124 may derive an MVP from the candidate list by using the candidate index. In addition, in terms of optimizing coding efficiency, the inter predictor 124 calculates a motion vector difference (MVD) by subtracting the MVP from the motion vector after determining the motion vector. In addition, the video encoding device may signal the candidate index and the MVD to the video decoding device.

The method of configuring the AMVP candidate list described above may be performed in the same manner by the inter predictor 544 in the video decoding device. The video decoding device may decode the candidate index and the MVD. The inter predictor 544 may derive the MVP from the candidate list by using the candidate index. The inter predictor 544 may restore the motion vector of the current block by adding the MVD and the MVP.

Hereinafter, the merge candidate list is used interchangeably with the merge list. In addition, the candidate list of the AMVP mode is used interchangeably with the AMVP list.

### III. Embodiments According to Present Disclosure

Hereinafter, embodiments according to the present disclosure are described based on a video decoding device but may be similarly applied to a video encoding device.

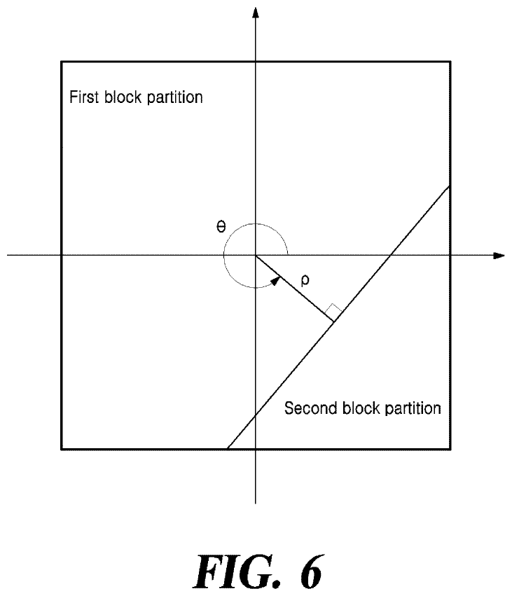

FIG. 6 is a diagram illustrating block partitioning for geometric motion prediction according to an embodiment of the present disclosure.

The inter predictor 544 according to the present disclosure bisects a current block based on a straight line orthogonal to a line segment having a constant angle 0 and a constant distance p based on the center of the block. Hereinafter, the two bisected blocks are referred to as a first block partition and a second block partition. In addition, the straight line bisecting the current block is referred to as a bisection line.

Here, the center of the block represents a virtual position in which a position at half the height of the block and a position at half the width of the block intersect with respect to the current block before partitioning. The angle θ represents an angle rotated counterclockwise from an imaginary horizontal axis passing through the center of the block to the line segment orthogonal to the bisection line. The distance ρ represents a distance between the center of the block and the bisection line.

As described above, the bisection line bisects the current block into two different block partitions. The inter predictor 544 according to the present disclosure divides the current block into two blocks, the first block partition and the second block partition, on which prediction is performed separately, based on the bisection line by using the geometric partitioning described above.

In particular, the related art GPM signals information on the bisection line, such as the example of FIG. 6, from the video encoding device to the video decoding device. The video decoding device may decode the geometric block partitioning of the current block by using the information on the parsed straight line. Here, the information on the straight line may include the angle θ and the distance p based on the center of the block.

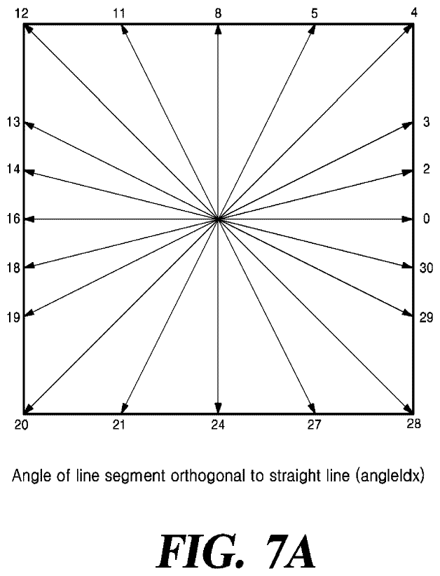

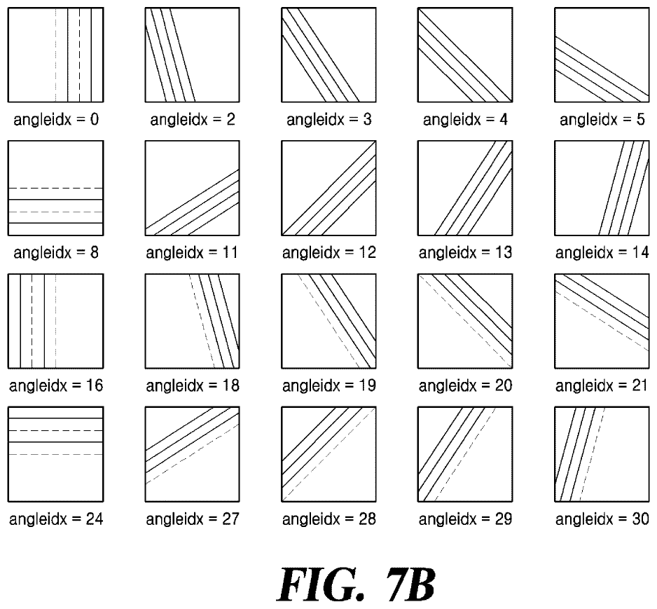

FIG. 7A and FIG. 7B are diagrams illustrating straight lines bisecting a block according to an embodiment of the present disclosure.

Meanwhile, unlike the method of signaling the angle and distance according to the example of FIG. 6, an index mapped by combining the angle and distance for partitioning the current block into the first block partition and the second block partition as shown in FIG. 7A, FIG. 7B, and Table 1 may be signaled from the video encoding device to the video decoding device.

As described above, the geometric partition shape is based on a straight line representing the bisection of a block. The information of the straight line may include an index distanceIdx representing the distance ρ from the center of the block to the straight line and an index angleIdx representing the angle θ of a line segment orthogonal to the straight line. The index representing the angle of the line segment orthogonal to the straight line may be set as illustrated in FIG. 7A. In addition, 64 geometric block partition shapes according to the angle and distance may be set as illustrated in FIG. 7B.

The 64 geometric partition shapes may be signaled using the merge_gpm_partition_idx syntax, which is an index indicating the geometric partition shape, as shown in Table 1. In other words, the shape of partitioning the current block into the first block partition and the second block partition according to various angles and various distances may be efficiently signaled using one index.

TABLE 1

| merge_gpm_partition_idx | 0 | 1 | 2 | 3 | 4 | 5 | 6 | 7 |
|---|---|---|---|---|---|---|---|---|
| angleIdx | 0 | 0 | 2 | 2 | 2 | 2 | 3 | 3 |
| distanceIdx | 1 | 3 | 0 | 1 | 2 | 3 | 0 | 1 |
| merge_gpm_partition_idx | 8 | 9 | 10 | 11 | 12 | 13 | 14 | 15 |
| angleIdx | 3 | 3 | 4 | 4 | 4 | 4 | 5 | 5 |
| distanceIdx | 2 | 3 | 0 | 1 | 2 | 3 | 0 | 1 |
| merge_gpm_partition_idx | 16 | 17 | 18 | 19 | 20 | 21 | 22 | 23 |
| angleIdx | 5 | 5 | 8 | 8 | 11 | 11 | 11 | 11 |
| distanceIdx | 2 | 3 | 1 | 3 | 0 | 1 | 2 | 3 |
| merge_gpm_partition_idx | 24 | 25 | 26 | 27 | 28 | 29 | 30 | 31 |
| angleIdx | 12 | 12 | 12 | 12 | 13 | 13 | 13 | 13 |
| distanceIdx | 0 | 1 | 2 | 3 | 0 | 1 | 2 | 3 |
| merge_gpm_partition_idx | 32 | 33 | 34 | 35 | 36 | 37 | 38 | 39 |
| angleIdx | 14 | 14 | 14 | 14 | 16 | 16 | 18 | 18 |
| distanceIdx | 0 | 1 | 2 | 3 | 1 | 3 | 1 | 2 |
| merge_gpm_partition_idx | 40 | 41 | 42 | 43 | 44 | 45 | 46 | 47 |
| angleIdx | 18 | 19 | 19 | 19 | 20 | 20 | 20 | 21 |
| distanceIdx | 3 | 1 | 2 | 3 | 1 | 2 | 3 | 1 |
| merge_gpm_partition_idx | 48 | 49 | 50 | 51 | 52 | 53 | 54 | 55 |
| angleIdx | 21 | 21 | 24 | 24 | 27 | 27 | 27 | 28 |
| distanceIdx | 2 | 3 | 1 | 3 | 1 | 2 | 3 | 1 |
| merge_gpm_partition_idx | 56 | 57 | 58 | 59 | 60 | 61 | 62 | 63 |
| angleIdx | 28 | 28 | 29 | 29 | 29 | 30 | 30 | 30 |
| distanceIdx | 2 | 3 | 1 | 2 | 3 | 1 | 2 | 3 |

The index distanceIdx derived from the example of FIG. 7B is a value that excludes the size of the current block. Therefore, the actual distance between the pixel in the current block and the straight line may be calculated by using the size information of the current block, the index angleIdx indicating the angle, and the index distanceIdx indicating the distance. Here, the actual distance is a value expressed in pixel units.

Meanwhile, the weight for each pixel in the current block may be calculated using the actual distance. For example, for one pixel in the first block partition, as the actual distance between the pixel and the straight line increases, the weight of the predictor of the first block partition as described above increases, and the weight of the predictor of the second block partition may decrease. For pixels located on the bisecting straight line, the two predictors may use weights having the same value. At this time, the sum of the weights of the two predictors for one pixel remains 1.

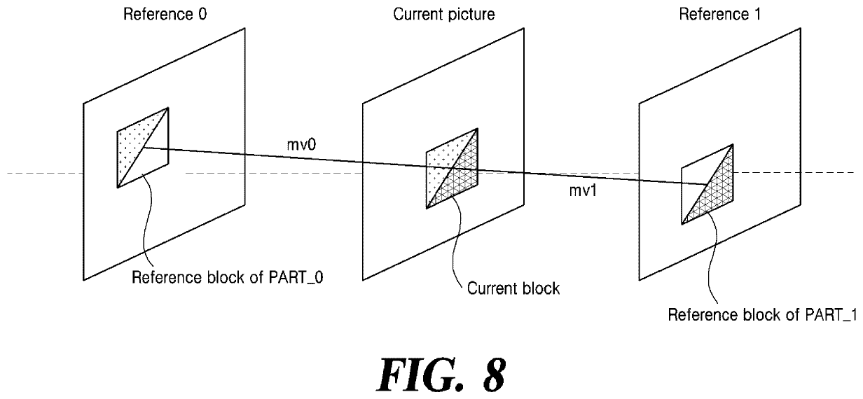

FIG. 8 is a diagram conceptually illustrating inter prediction using geometric partitioning.

As in the example of FIG. 8, for two different block partitions of the current block within the current picture, the inter predictor 542 performs prediction using each motion vector (mv0 or mv1). For the prediction block for the first block partition and the prediction block for the second block partition, the inter predictor 542 performs a weighted sum-based blending process to generate a final prediction block of the current block. In the example of FIG. 8, PART_0 represents the first block partition, and PART_1 represents the second block partition. In addition, a reference block of PART_0 represents the prediction block for the first block partition, and a reference block of PART_1 represents the prediction block for the second block partition.

In order to perform inter prediction of the current block as illustrated in FIG. 8, the video decoding device acquires a first prediction block using the motion vector for the first block partition and acquires a second prediction block using the motion vector for the second block partition. At this time, in the process of acquiring the prediction block for each block partition, the video decoding device may acquire the prediction blocks multiplied by different weights according to the pixel position as described above. In addition, the video decoding device may use a shift operation and a clipping operation in the process of generating a final prediction block from the prediction blocks multiplied by the weights.

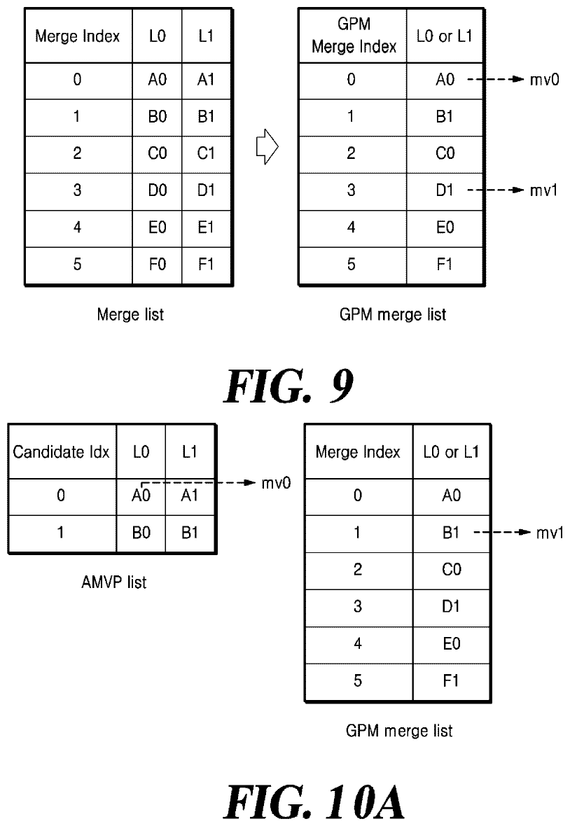

FIG. 9 is a diagram illustrating a GPM merge list used for geometric motion prediction.

In performing the geometric motion prediction illustrated in FIG. 8, the inter predictor 544 may select motion information for motion prediction from the merge list as in the example of FIG. 9 and then may use the selected motion information.

However, unlike the existing block-unit motion prediction technology, the inter predictor 544 performs unidirectional prediction for one block partition by limiting the prediction directionality as in the example of FIG. 9 for geometric motion prediction. This is because, compared to block unit-based motion prediction, when motion prediction is performed according to bidirectional prediction for each block partition in geometric motion prediction, the memory bandwidth used for prediction increases by two times. Therefore, in order to efficiently solve the above-described memory bandwidth increase problem, a technique for limiting the directionality of prediction for each block partition may be applied.

In a case in which the directionality of prediction is limited for each block partition in geometric motion prediction, a GPM merge list for geometric motion prediction may be generated using an existing merge list. To generate the GPM merge list, the video decoding device first configures the existing merge list. Thereafter, the video decoding device may generate a GPM merge list for geometric motion prediction from the merge list according to the prediction directionality and the order in the list. At this time, the video decoding device adds motion information in an LO direction to the GPM merge list to generate a merge candidate for geometric motion prediction of the first block partition. In addition, the video decoding device may add the motion information in the L1 direction to the GPM merge list to generate a merge candidate for geometric motion prediction of the second block partition. In other words, the video decoding device may derive unidirectional motion information in one direction from the existing bidirectional motion information and then may add the derived motion information to the GPM merge list.

As shown in the example of FIG. 9, in the existing geometric motion prediction method, the video decoding device may use the merge candidate in the GPM merge list as motion information for motion prediction of the first block partition and the second block partition. Alternatively, the motion information for motion prediction of the first block partition and the second block partition may be derived.

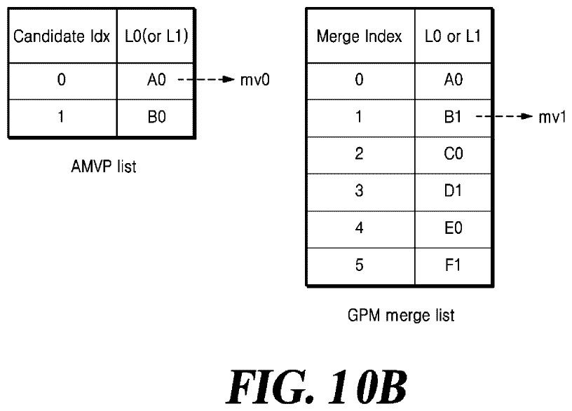

FIG. 10A and FIG. 10B are diagrams illustrating an AMVP list and a GPM merge list used for geometric motion prediction according to an embodiment of the present disclosure.

In performing the geometric motion prediction illustrated in FIG. 8, the inter predictor 544 may use the AMVP mode and the merge mode together, as shown in the examples of FIG. 10A and FIG. 10B.

For example, as in the example of FIG. 10A, the inter predictor 544 performs motion prediction by using motion information acquired from the AMVP list based on the AMVP mode for one of the first block partition and the second block partition. In addition, the inter predictor 544 may perform motion prediction by using motion information acquired from the GPM merge list based on the merge mode for the other block partition.

In the example of FIG. 10A, the video decoding device uses the existing AMVP list to apply the AMVP mode. At this time, information on the prediction direction may be determined as follows. For example, as information on the prediction direction, a flag indicating the prediction direction for candidates included in the AMVP list may be signaled from the video encoding device to the video decoding device. Alternatively, a prediction direction predefined between the video encoding device and the video decoding device may be used. In the example of FIG. 10A, the L0 direction is applied as the prediction direction of the AMVP list, and the L1 direction is applied as the prediction direction of the GPM merge list.

As another example, as in the example of FIG. 10B, the inter predictor 544 may perform motion prediction by using motion information obtained from the GPM AMVP list based on the AMVP mode for one of the first block partition and the second block partition.

At this time, the GPM AMVP list may be configured similarly to the method of generating the GPM merge list from the existing merge list. To generate the GPM AMVP list, the video decoding device first configures the existing AMVP list. Thereafter, the video decoding device generates the GPM AMVP list from the existing AMVP list to include unidirectional motion information. At this time, information on the prediction direction may be determined as follows. For example, as information on the prediction direction, a flag indicating a prediction direction of candidates included in the GPM AMVP list may be signaled from the video encoding device to the video decoding device. Alternatively, a predefined prediction direction may be used between the video encoding device and the video decoding device. Therefore, the GPM AMVP list may be configured to include only motion information corresponding to unidirectional motion. In the example of FIG. 10B, the GPM AMVP list includes motion information in the L0 direction.

Compared to the existing geometric motion prediction method using only the existing merge mode, the geometric motion prediction using the AMVP mode and the merge mode according to the present disclosure may generate more accurate motion information by using the AMVP mode for at least one direction. Accordingly, the prediction accuracy may be improved compared to the geometric motion prediction method using only the existing merge mode. In addition, since accurate motion information may be signaled using the AMVP mode, the block partition shape may be determined using the same predefined arithmetic operation between the video encoding device and the video decoding device based on the corresponding motion information. In other words, signaling of additional information on the geometric partition shape of the current block may be omitted. Therefore, since the block may be partitioned by using the block partition shape derived according to the motion information of the AMVP mode, the signaling overhead for the block partition shape may be reduced, thereby improving the coding efficiency.

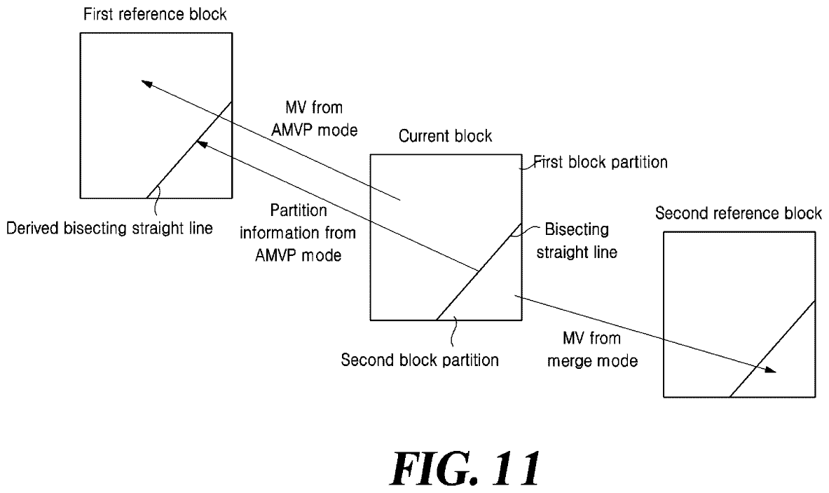

FIG. 11 is a diagram illustrating geometric motion prediction using both the AMVP mode and the merge mode according to one embodiment of the present disclosure.

As in the example of FIG. 11, the current block may be partitioned into a first block partition and a second block partition based on a bisecting straight line. At this time, the bisecting straight line of the current block may be derived from motion information of the first block partition. In the geometric motion prediction according to the present disclosure, the inter predictor 544 derives the geometric block partition shape of the current block by using a reference block referenced by the motion information of the first block partition. The inter predictor 544 acquires motion information of the first block partition based on a motion vector predictor and a motion vector difference obtained from the GPM AMVP list. The inter predictor 544 may designate a specific position of a reference picture using the obtained motion information. The inter predictor 544 may set the same reference block as the current block based on a specific position and then may perform a process of deriving a geometric partition shape within a region of the reference block. The inter predictor 544 performs an operation to search for a boundary region within a block when deriving a geometric partition shape, thereby deriving a bisecting straight line of the reference block.

As an example, a directionality deriving method based on a Sobel filter may be used to search for a boundary region within a block. At this time, a directionality prediction operation using a 3×3 kernel may be performed as an example of the above-described Sobel filter-based operation. In addition, the inter predictor 544 may select one of predefined geometric partition shapes when deriving a geometric partition shape of a block using the Sobel filter.

Meanwhile, when determining a geometric partition shape, the inter predictor 544 may derive an arbitrary partition shape that partitions a block into an arbitrary shape based on the boundary of an object existing within a reference block, in addition to a method of partitioning a block using a single straight line. A method of performing prediction using the above-described arbitrary partition shape is also included in the scope of the present disclosure. In addition, a bisecting curve may be used to express such an arbitrary partition shape. Hereinafter, the bisecting straight line and bisecting curve are collectively expressed as a bisecting edge.

In order to perform geometric motion prediction using the AMVP mode and the MERGE mode according to the present disclosure, the video decoding device derives motion information of the first block partition by using the GPM AMVP list and then selects the first reference block by using the derived motion information of the first block partition. The video decoding device derives the geometric partition shape from the selected first reference block. The video decoding device derives motion information of the second block partition by using the GPM merge list and then selects the second reference block by using the derived motion information of the second block partition. The video decoding device generates a final prediction block by using a blending process based on the geometric partition shape derived from the first reference block for the first reference block and the second reference block.

Hereinafter, for geometric motion prediction using the merge mode as illustrated in FIG. 9, motion information is signaled as follows.

The video decoding device first decodes geometric partition information from a bitstream. At this time, the video decoding device may decode an index mapped to a single representative value for the shape of the block partition. In other words, the video decoding device may decode merge_gpm_partition_idx, which is an index indicating the partition shape as geometrical partition information. At this time, this index may indicate a combination of an angle and a distance for partitioning the current block into the first block partition and the second block partition according to the shape of the block partition.

Thereafter, the video decoding device decodes the motion information of the first block partition from the bitstream and then decodes the motion information of the second block partition. Here, the motion information of the first block partition includes merge_gpm_idx0, which is an index indicating the first candidate in the GPM merge list. In addition, the motion information of the second block partition includes merge_gpm_idx1, which is an index indicating the second candidate in the GPM merge list.

The video decoding device may reconfigure the GPM merge list by processing the existing merge list into unidirectional motion information in a case in which the directionality of geometric motion prediction is limited to one direction in order to reduce a memory bandwidth for prediction.

The video decoding device acquires a first reference block (i.e., a first prediction block) by using the motion information of the first block partition. In addition, the video decoding device acquires a second reference block (i.e., a second prediction block) by using the motion information of the second block partition. Finally, the video decoding device may generate a final prediction block of the current block by blending the first reference block and the second reference block using the decoded geometric block partition shape.

Hereinafter, a method of signaling motion information for geometric motion prediction using the AMVP mode and the merge mode, as illustrated in FIGS. 10 and 11, is described.

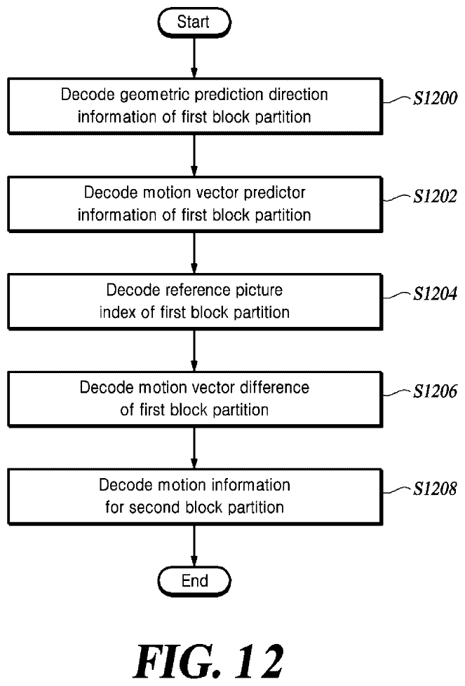

FIG. 12 is a flowchart illustrating a method of decoding motion information by the video decoding device according to another embodiment of the present disclosure.

As described above, the block partition shape may be determined based on the AMVP mode. Therefore, in the case of geometric motion prediction that uses both the AMVP mode and the merge mode, decoding of geometric partition information may be omitted.

In the case of using both the AMVP mode and the merge mode, motion information for the first block partition may include geometric prediction direction information, motion vector predictor information, a reference picture index, and a motion vector difference. In addition, motion information for the second block partition may include motion information derived from the GPM merge list.

The video decoding device decodes the geometric prediction direction information of the first block partition from the bitstream (S1200). Here, the geometric prediction direction information of the first block partition indicates which reference picture list among the reference picture lists of L0 and L1 is used. At this time, the information of the reference picture list may be a flag having a value of 0 or 1. Hereinafter, as the geometric prediction direction information, a flag indicating the L0 or L1 reference picture list is expressed as gpm_dir_flag.

The video decoding device decodes motion vector predictor information of the first block partition from the bitstream (S1202). If the AMVP list includes two candidates as in the example of FIG. 10A, the motion vector predictor information may be a flag indicating a candidate index of one of the AMVP candidates. Hereinafter, as the motion vector predictor information, the flag indicating one of the candidates is expressed as gpm_mvp_flag. The video decoding device may select a candidate according to the value of gpm_mvp_flag. Thereafter, based on the geometric prediction direction of the first block partition, a unidirectional motion vector predictor of the first block partition may be set from the motion vector predictor(s) of the selected candidate.

As another example, if the GPM AMVP list includes two candidates as in the example of FIG. 10B, the motion vector predictor information may be a flag indicating one of the GPM AMVP candidates. Similarly, as the motion vector predictor information, the flag indicating one of the candidates is expressed as gpm_mvp_flag. The video decoding device may set the motion vector of the candidate selected according to the value of gpm_mvp_flag as the motion vector predictor of the first block partition. As described above, in order to match the geometric prediction direction information of the first block partition, the GPM AMVP list may only include motion information corresponding to one direction.

The video decoding device decodes the reference picture index of the first block partition from the bitstream (S1204). The reference picture index may be an index indicating one reference picture included in the L0 or L1 reference picture list based on the geometric prediction direction information of the first block partition. Hereinafter, the index indicating the reference picture for the first block partition is expressed as gpm_ref_idx.

The video decoding device decodes the motion vector difference of the first block partition from the bitstream (S1206).

Here, the motion vector difference of the first block partition represents the difference between the motion vector predictor of the first block partition and the motion vector of the first block partition. At this time, the motion vector difference may be parsed into x, y coordinate values of the motion vector. Alternatively, the motion vector difference may be parsed into predefined direction information and distance information from the origin for the corresponding direction. Hereinafter, the motion vector difference is expressed as gpm_mvd_coding.

After decoding all information on the AMVP mode for the first block partition, the video decoding device acquires the first reference block (i.e., the first prediction block) of the current block by using the motion information of the first block partition. In addition, the video decoding device derives the geometric block partition shape of the current block by using the first reference block as described above.

The video decoding device decodes motion information for the second block partition from the bitstream (S1208).

Here, the motion information of the second block partition may be an index indicating one merge candidate in the GPM merge list. Hereinafter, the motion information of the second block partition is expressed as merge_gpm_idx. The video decoding device performs motion prediction by using the motion information of the merge candidate for the second block partition as it is, thereby acquiring the second reference block (i.e., the second prediction block) of the current block.

Finally, the video decoding device may generate the final prediction block of the current block by blending the first reference block and the second reference block based on the derived geometric block partition shape.

Meanwhile, if a predefined direction is used between the video encoding device and the video decoding device as the geometric prediction direction of the first block partition, the operation of decoding the information of the geometric prediction direction of the first block partition may be omitted. In other words, signaling of the information of the geometric prediction direction may be omitted.

As an example, the geometric prediction direction of the first block partition may be limited to L0. Accordingly, if the geometric prediction direction of the first block partition is limited to L0, the information of the motion vector predictor of the first block partition, the reference picture index of the first block partition, and the information of the motion vector difference of the first block partition all represent information limited to the L0 direction. In addition, for the second block partition, the merge list may be configured by limitedly using the motion information of the L1 direction.

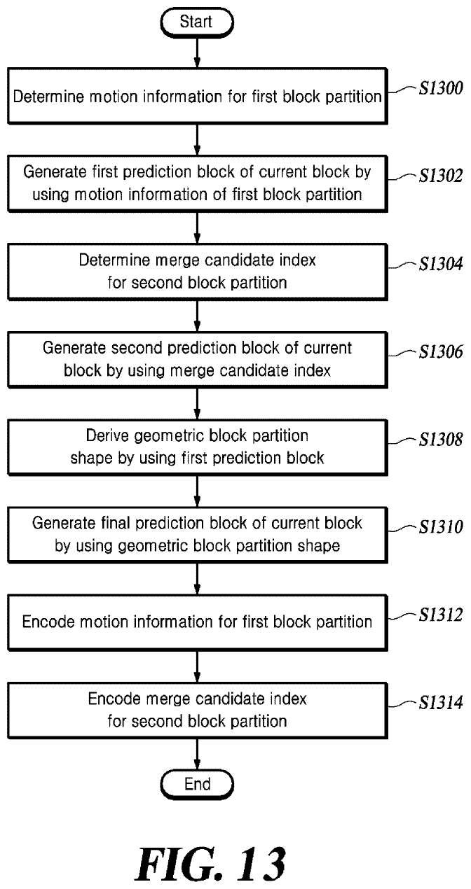

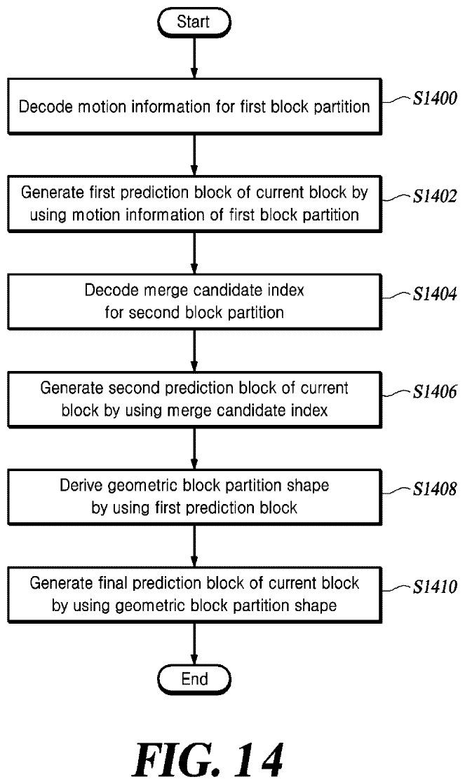

Hereinafter, a method for predicting a current block according to geometric motion prediction using both an AMVP mode and a merge mode is described with reference to FIGS. 13 and 14.

FIG. 13 is a flowchart illustrating a method for a video encoding device to predict a current block according to an embodiment of the present disclosure.

The video encoding device determines motion information for a first block partition of a current block (S1300). Here, the motion information of the first block partition may include geometric prediction direction information, motion vector predictor information, a reference picture index, and a motion vector difference.

The video encoding device determines a flag indicating an L0 or L1 reference picture list as geometric prediction direction information.

In addition, the video encoding device determines a unidirectional motion vector of the first block partition according to the geometric prediction direction information.

The video encoding device generates an AMVP list of the current block. The video encoding device determines a flag indicating one of the candidates in the AMVP list of the current block as motion vector predictor information. The video encoding device determines a unidirectional motion vector predictor by using the geometric prediction direction information, the motion vector predictor information, and the AMVP list.

The video encoding device determines an index indicating a reference picture included in the L0 or L1 reference picture list based on the geometric prediction direction information as a reference picture index.

The video encoding device subtracts the motion vector predictor from the motion vector to generate a motion vector difference of the first block partition.

In terms of rate distortion optimization, the video encoding device may determine geometric prediction direction information, a motion vector of the first block partition, motion vector predictor information, and a reference picture index.

At this time, when a predefined direction is used as the geometric prediction direction of the first block partition, the video encoding device may omit determining the geometric prediction direction information.

The video encoding device generates a first prediction block of the current block by using the motion information of the first block partition (S1302).

The video encoding device may generate the first prediction block by using the motion vector and the reference picture index.

The video encoding device determines a merge candidate index for the second block partition of the current block (S1304).

In terms of rate distortion optimization, the video encoding device may determine the merge candidate index.

The video encoding device generates a second prediction block of the current block by using the merge candidate index (S1306). The video encoding device may acquire motion information of the second block partition from the GPM merge list according to the merge candidate index and then may generate the second prediction block by using the motion information of the second block partition.

To generate the GPM merge list, the video encoding device first generates a merge list of the current block. The video encoding device generates a GPM merge list from the merge list, and each candidate in the GPM merge list includes unidirectional motion information.

The video encoding device derives a geometric block partition shape that partition the current block into the first block partition and the second block partition by using the first prediction block (S1308).

The video encoding device performs an arithmetic operation to search for a boundary region within a region of the first prediction block, thereby deriving a bisecting boundary that divides the first prediction block into the first block partition and the second block partition. Thereafter, the video encoding device may select one of the predefined geometric block partition shapes based on the bisecting boundary.

The video encoding device generates a final prediction block of the current block by using the geometric block partition shape (S1310). The video encoding device may generate the final prediction block by performing weighted sum-based blending on the first prediction block and the second prediction block by using the geometric block partition shape.

The video encoding device encodes motion information for the first block partition (S1312).

Meanwhile, when the predefined direction is used as the geometric prediction direction of the first block partition, the video encoding device may omit encoding of geometric prediction direction information among the motion information for the first block partition.

The video encoding device encodes a merge candidate index for the second block partition (S1314).

FIG. 14 is a flowchart illustrating a method for predicting a current block by a video decoding device according to an embodiment of the present disclosure.

The video decoding device decodes motion information for a first block partition of a current block from a bitstream (S1400). Here, the motion information of the first block partition includes geometric prediction direction information, motion vector predictor information, a reference picture index, and a motion vector difference.

According to the order illustrated in FIG. 12, the video decoding device may decode motion information of the first block partition. In other words, the video decoding device decodes a flag indicating an L0 or L1 reference picture list as geometric prediction direction information. The video decoding device decodes a flag indicating one of the candidates in the AMVP list of the current block as motion vector predictor information. The video decoding device decodes an index indicating a reference picture included in the L0 or L1 reference picture list based on geometric prediction direction information as a reference picture index. In addition, the video decoding device decodes the motion vector difference.

Meanwhile, when the predefined direction is used as the geometric prediction direction of the first block partition, the video decoding device may omit decoding of the geometric prediction direction information.

The video decoding device generates the first prediction block of the current block by using the motion information of the first block partition (S1402).

The video decoding device generates an AMVP list. The video decoding device acquires a unidirectional motion vector predictor by using the geometric prediction direction information, the motion vector predictor information, and the AMVP list. The video decoding device generates a motion vector of the first block partition by adding the motion vector predictor and the motion vector difference. The video decoding device may generate a first prediction block by using the motion vector and the reference picture index.

The video decoding device decodes a merge candidate index for the second block partition of the current block from the bitstream (S1404).

The video decoding device generates the second prediction block of the current block by using the merge candidate index (S1406). The video decoding device may acquire motion information of the second block partition from the GPM merge list according to the merge candidate index and then may generate the second prediction block by using the motion information of the second block partition.

To generate the GPM merge list, the video decoding device first generates a merge list of the current block. The video decoding device generates a GPM merge list from the merge list, and each candidate in the GPM merge list includes unidirectional motion information.

The video decoding device derives a geometric block partition shape that partitions the current block into the first block partition and the second block partition by using the first prediction block (S1408).

The video decoding device performs an arithmetic operation of searching for a boundary region within the region of the first prediction block to derive a bisecting boundary that divides the first prediction block into the first block partition and the second block partition. Thereafter, the video decoding device may select one of the predefined geometric block partition shapes based on the bisecting boundary.

The video decoding device generates a final prediction block of the current block by using the geometric block partition shape (S1410). The video decoding device may generate the final prediction block by performing weighted sum-based blending on the first prediction block and the second prediction block by using the geometric block partition shape.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### Reference Numerals

124: inter predictor
155: entropy encoder
510: entropy decoder
544: inter predictor

### CROSS-REFERENCE TO RELATED APPLICATIONS

This application claims priority to and the benefit of Korean Patent Application No. 10-2022-0059398 filed on May 16, 2022, and Korean Patent Application No. 10-2023-0051381, filed on Apr. 19, 2023, the entire contents of each of which are incorporated herein by reference.

What is Claimed is:

1. A method of decoding a current block, performed by a video decoding device, the method comprising:
decoding motion information for a first block partition of the current block from a bitstream;
generating a first prediction block of the current block by using the motion information of the first block partition;
decoding a merge candidate index for a second block partition of the current block from the bitstream;
acquiring motion information of the second block partition from a geometric partition mode (GPM) merge list based on the merge candidate index and then generating a second prediction block of the current block by using the motion information of the second block partition;
deriving a geometric block partition shape that partitions the current block into the first block partition and the second block partition by using the first prediction block; and
blending the first prediction block and the second prediction block by using the geometric block partition shape to generate a final prediction block of the current block.

2. The method of claim 1, wherein the motion information of the first block partition includes geometric prediction direction information, motion vector predictor information, a reference picture index, and a motion vector difference.

3. The method of claim 2, wherein decoding the motion information for the first block partition includes:
decoding a flag indicating an L0 or L1 reference picture list as the geometric prediction direction information; and
decoding a flag indicating one of candidates in an advanced motion vector prediction (AMVP) list of the current block as the motion vector predictor information.

4. The method of claim 3, wherein decoding the motion information for the first block partition includes:
decoding an index indicating a reference picture included in the L0 or L1 reference picture list based on the geometric prediction direction information as the reference picture index; and
decoding the motion vector difference from the bitstream.

5. The method of claim 3, wherein, when a predefined direction is used as geometric prediction direction of the first block partition, decoding the geometric prediction direction information is omitted.

6. The method of claim 4, wherein generating the first prediction block includes:
generating the AMVP list; and
acquiring a unidirectional motion vector predictor by using the geometric prediction direction information, the motion vector predictor information, and the AMVP list.

7. The method of claim 6, wherein generating the first prediction block includes:
generating a motion vector by adding the motion vector predictor and the motion vector difference; and
generating the first prediction block by using the motion vector and the reference picture index.

8. The method of claim 1, further comprising:
generating a merge list of the current block; and
generating the GPM merge list from the merge list,
wherein each candidate in the GPM merge list includes unidirectional motion information.

9. The method of claim 1, wherein deriving the geometric block partition shape includes:
performing an arithmetic operation of searching for a boundary region within a region of the first prediction block to derive a bisecting boundary that divides the first prediction block into the first block partition and the second block partition; and
selecting one of predefined geometric block partition shapes based on the bisecting boundary.

10. The method of claim 2, wherein the motion information of the second block partition has a different prediction direction from the motion information for the first block partition, based on the geometric prediction direction information.

11. A method of predicting a current block, performed by a video encoding device, the method comprising:
determining motion information for a first block partition of the current block;
generating a first prediction block of the current block by using the motion information of the first block partition;
determining a merge candidate index for a second block partition of the current block;
acquiring motion information of the second block partition from a geometric partition mode (GPM) merge list based on the merge candidate index and then generating a second prediction block of the current block by using the motion information of the second block partition;
deriving a geometric block partition shape that divides the current block into the first block partition and the second block partition by using the first prediction block; and
blending the first prediction block and the second prediction block by using the geometric block partition shape to generate a final prediction block of the current block.

12. The method of claim 11, wherein the motion information of the first block partition includes geometric prediction direction information, motion vector predictor information, a reference picture index, and a motion vector difference.

13. The method of claim 12, further comprising:
encoding the motion information for the first block partition; and
encoding the merge candidate index for the second block partition.

14. The method of claim 13, wherein encoding motion information for the first block partition includes:
encoding a flag indicating an L0 or L1 reference picture list as the geometric prediction direction information; and
encoding a flag indicating one of candidates in an advanced motion vector prediction (AMVP) list of the current block, as the motion vector predictor information.

15. The method of claim 14, wherein encoding the motion information for the first block partition includes:
encoding an index indicating a reference picture included in the L0 or L1 reference picture list based on the geometric prediction direction information, as the reference picture index; and
encoding the motion vector difference.

16. The method of claim 14, wherein, when a predefined direction is used as geometric prediction direction of the first block partition, determining and encoding the geometric prediction direction information are omitted.

17. A computer-readable recording medium that stores a bitstream generated by a video encoding method, the video encoding method comprising:
determining motion information for a first block partition of a current block;
generating a first prediction block of the current block by using the motion information of the first block partition;
determining a merge candidate index for a second block partition of the current block;
acquiring motion information of the second block partition from a geometric partition mode (GPM) merge list based on the merge candidate index and then generating a second prediction block of the current block by using the motion information of the second block partition;
deriving a geometric block partition shape that divides the current block into the first block partition and the second block partition by using the first prediction block; and
blending the first prediction block and the second prediction block by using the geometric block partition shape to generate a final prediction block of the current block.
